(19) United States
(12) Patent Application Publication
(10) Pub. No.: US 2017/0234218 A1
(43) Pub. Date: Aug. 17, 2017

(54) Turbine Stator Vane with Multiple Outer Diameter Pressure Feeds

(71) Applicant: Florida Turbine Technologies, Inc., Jupiter, FL (US)

(72) Inventors: Michelle I. Cupini, Jupiter, FL (US); Stephen E. Murray, Port St. Lucie, FL (US)

(21) Appl. No.: 15/405,467

(22) Filed: Jan. 13, 2017

Related U.S. Application Data
(60) Provisional application No. 62/295,747, filed on Feb. 16, 2016.

(51) Int. Cl. F02C 3/22; F01D 25/12; F01D 9/02; F02C 3/04; F02C 7/18

(52) U.S. Cl. CPC F02C 3/22; F02C 3/04; F02C 7/18; F01D 9/02; F01D 25/12; F05D 2220/32; F05D 2240/81; F05D 2260/202

(57) ABSTRACT

A stator vane assembly for a gas turbine engine in which both higher pressure cooling air and lower pressure cooling air are both supplied to the stator vane assembly to cool both an airfoil and inner and outer diameter endwall cavities of the stator vane assembly, in which the spent higher pressure cooling air is then discharged into a combustor of the gas turbine engine. The higher pressure cooling air flows through a closed loop cooling circuit formed within the stator vane assembly while the lower pressure cooling air is discharged through exit holes into the hot gas stream of the turbine.

### CROSS-REFERENCE TO RELATED APPLICATIONS

This application claims the benefit to U.S. Provisional Application 62/295,747 filed on Feb. 16, 2016 and entitled TURBINE STATOR VANE WITH MULTIPLE OD PRESSURE FEEDS.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to a gas turbine engine, and more specifically to an industrial gas turbine engine with spent airfoil cooling air discharged into a combustor.

Description of the Related Art including information disclosed under 37 CFR 1.97 and 1.98

The current state-of-the-art in gas turbine vane OD (Outer Diameter) multi-cooling feed is shown in the prior art U.S. Pat. No. 8,961,108 issued to Bergman et al. on Feb. 24, 2015 shown in FIG. 1. In this approach, the cooling system contains two cooling flow passageways through a mounting hook, that are not in fluid communication with each other, fed by the same first high pressure plenum. A second plenum supplies the aft cavities of the stator with an intermediate pressure. High pressure and intermediate pressure flows are extracted from the flow of the compressed air from the compressor located on the same centerline. As shown, the flow is provided through plenums at the BOAS (Blade Outer Air Seal) and the vane OD platform. The flow is then routed and split through the mounting hooks (passageways 1 & 2, fed from plenum 1) and direct into the aft cooling passages for cooling flow passageway 3 (F3, fed from plenum 2).

In this current state-of-the-art multi-feed cooling technique of the Bergman et al. patent, the first plenum supplied by the compressor high pressure air feeds the first passage and second passages. The first passage supplies the compressor bleed high pressure cooling air to the adjacent BOAS. The second passage is routed through the mounting hook and supplies the same (first) plenum cooling air to the vane OD and the airfoil leading edge. The second plenum, supplied by the compressor from a higher stage (lower pressure) then feeds the third passage from the vane OD into the trailing edge cooling channels of the airfoil. The second passage cooling air then exits the leading edge through film holes and the third passage cooling air exits out the trailing edge to mix with the hot gas stream passing through the turbine. The mixing of spent cooling air with the hot gas stream results in performance and power losses to the machine. Higher pressure air also introduces leakages at the vane OD platform, which in this technique were reduced with the addition of multiple seals, shown in the Bergman patent U.S. Pat. No. 8,961,108. However, with high pressure or over-pressurized supply air, these seals can contribute to large leaks of the cooling air into the gas path.

Introduction of over-pressurized cooling air recirculated through turbine stator vane would introduce a significant amount of leakage flow at the OD and ID (Inner Diameter) if used for cooling the surrounding hooks, pre-swirler or U-rings, downstream ring segments, and the back side of vane platforms. A second lower-pressure source is introduced and an updated configuration to fit multiple feed plumbing into the vane OD developed here to address this issue.

### BRIEF SUMMARY OF THE INVENTION

The present invention relates generally to cooled turbine components and specifically to turbine stator vanes fed with multiple pressures including recirculated cooling air pressurized over compressor exit, to reduce leakages while enhancing power output and thermodynamic efficiency. A higher pressure cooling air is passed through a stator vane in a closed loop cooling circuit in which the spent cooling air is then discharged into the combustor. The higher pressure cooling air is required to provide both cooling for the stator vane and have enough pressure to flow into the combustor. A lower pressure cooling air is used to provide cooling for the endwalls and hooks of the stator vane, where this spent cooling air is then discharged into the hot gas stream.

### BRIEF DESCRIPTION OF THE SEVERAL VIEWS OF THE DRAWINGS

FIG. 1 shows a cross section top view of a closed loop cooling circuit for a turbine stator vane cooling circuit of the prior art.

FIG. 2 shows a cross section view of a stator vane in a turbine with the cooling circuit of the present invention.

FIG. 3 shows a top view of a vane doublet with the cooling circuit of the present invention.

FIG. 4 shows a top view of a vane singlet with the cooling circuit of the present invention.

FIG. 5 shows a combined cycle power plant with an industrial gas turbine engine of the present invention.

FIG. 6 shows another embodiment of a combined cycle power plant with an industrial gas turbine engine of the present invention in which the turbine stator vane is cooled.

FIG. 7 shows another embodiment of a combined cycle power plant with an industrial gas turbine engine of the present invention in which the turbine stator vane is cooled.

### DETAILED DESCRIPTION OF THE INVENTION

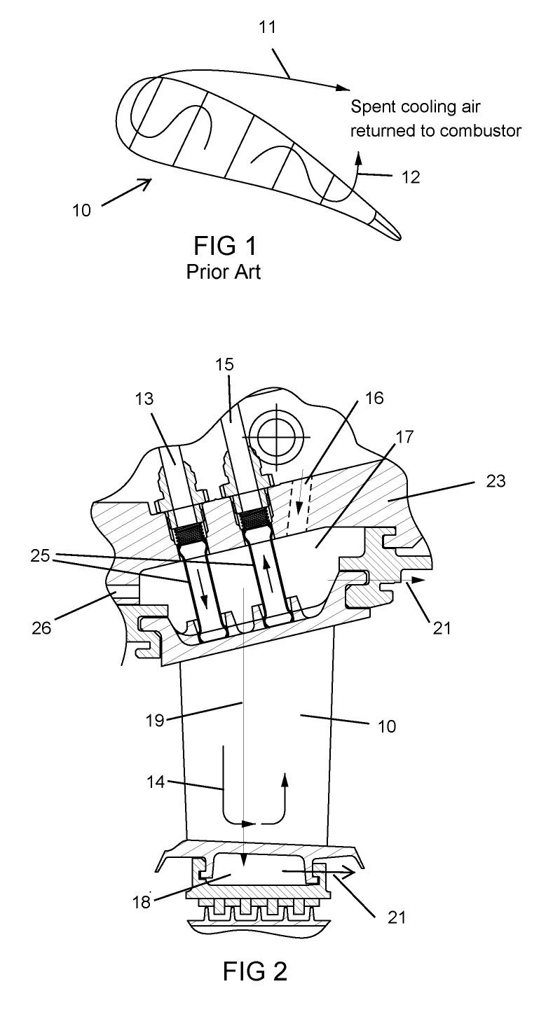

To solve problems of the current state-of-the-art and other methods utilizing pressures higher than compressor exit (over-pressurized cooling supply air) recirculated, the present invention proposes the use of multiple feed and extraction tubes consisting of supplies from over-pressurized air and compressor bleed flows, organized at the vane Outer Diameter (OD). The present invention is shown in conceptual form in the FIGS. 1-4, but not limited to the shown orientation.

FIG. 1 shows a stator vane 10 with a first cooling circuit 11 for a forward section of the airfoil and a second cooling circuit 12 for an aft section of the airfoil. Both cooling circuits 11 and 12 are higher pressure cooling air that first provides cooling for the stator vane 10 and second has enough remaining pressure to be discharged into the combustor along with the compressed air discharged from the compressor. FIG. 1 shows two high pressure cooling circuits, but could have only one high pressure cooling circuit where the spent cooling air is discharged into the combustor.

FIG. 2 shows a side view of a stator vane with cooling circuits according to the present invention where a higher pressure cooling air is used along with a lower pressure cooling air to provide cooling for the airfoil as well as the endwalls and the hooks of the stator vane. A higher pressure cooling air flows into the higher pressure cooling air supply passage 13, which then flows thru an internal airfoil cooling circuit 14 to provide cooling for the airfoil of the stator vane 10. The higher pressure spent cooling air then flows out from the airfoil through cooling air exit passage 15 where the spent cooling air is discharged into the combustor. This higher pressure cooling air can be merged with compressor outlet air in a diffuser positioned between the compressor outlet and the combustor inlet. The higher pressure cooling air circuit is a closed loop cooling circuit in which none of the cooling air is discharged out film holes into the hot gas stream passing thru the turbine.

The OD endwall and ID endwall and hooks of the stator vane 10 are cooled using lower pressure cooling air such as that bleed off from the compressor. A lower pressure cooling air feed tube 16 delivers lower pressure cooling air to the vane 10 to provide cooling for the OD endwall cavity 17 and the ID endwall cavity 18 and surrounding areas thru a lower pressure cooling air bypass passage 19 formed within the airfoil of the stator vane 10. The lower pressure cooling air can be discharged from the two endwall cavities 17 and 18 into the hot gas stream thru exit holes 21 or other exits including trailing edge exit holes or other exit holes in the airfoil. By using lower pressure cooling air instead of the high pressure cooling air in places that discharge the spent cooling air from the vane and into the hit gas stream, higher pressure seals are not required. The higher pressure cooling air is required so that the spent cooling air from the stator vane has a high enough pressure to be discharged into the combustor. If the higher pressure cooling air was used in places where the lower pressure cooling air is used, the higher pressure cooling air would produce a large cooling air leakage thru the seals and into the hot gas stream. Thus, less higher pressure cooling air would be available for discharge into the combustor after cooling of the stator vane and surrounding areas.

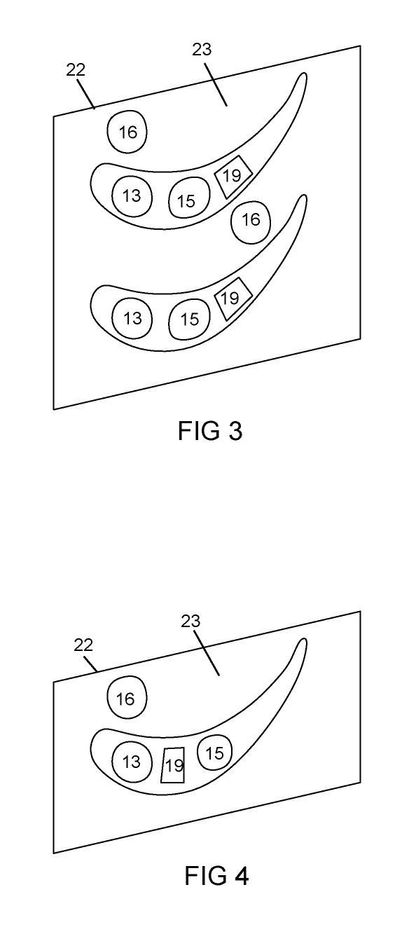

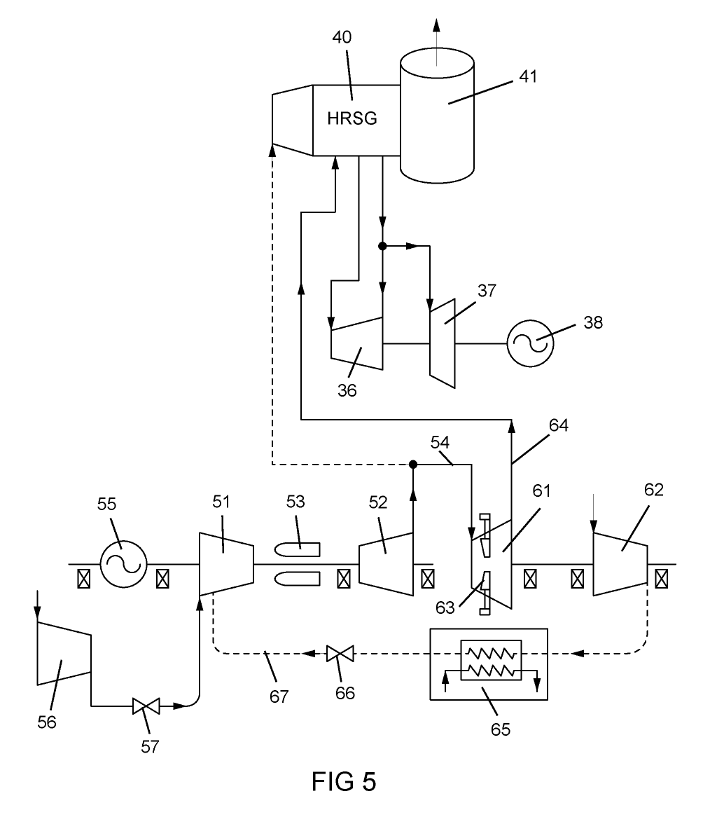

FIG. 3 shows a doublet stator vane segment in which the vane segment has two airfoils extending between the endwall cavities. FIG. 3 shows a turbine vane carrier 22 with an OD platform 23, a lower pressure cooling air supply passage 16 and a higher pressure cooling air supply passage 13. The higher pressure cooling air supply passage 13 and exit passage 15 and the lower pressure cooling air bypass channel 19 formed within the airfoil is shown in FIG. 3 for the two airfoils. A second lower pressure cooling air supply passage 16 is shown in the OD endwall in-between the two airfoils. FIG. 4 shows a similar arrangement for a single airfoil stator vane segment.

The higher pressure cooling air circuit and the lower pressure cooling air circuit are separate cooling circuits and not in fluid communication with each other in order to reduce any leakages. Higher pressure cooling air feed tubes 25 (FIG. 2) are used to connect the supply and exit passages 13 and 15 to the airfoil cooling passages 14 formed within the airfoil and prevent the higher pressure cooling air from leaking into the lower pressure cooling air of the OD endwall cavity 17. The lower pressure cooling air feed tube 16 is formed as a hole in the turbine vane carrier to the OD cavity. The lower pressure feed tube 16 can also be sourced to adjacent ring segments through mounting hooks on the vane.

The lower pressure cooling air source also feeds the stator vane ID cavity 18 cooling through a cooling air bypass channel 19 formed within the airfoil of the stator vane. A second form fitted tube 25 is connected directly to the vane OD cooling exit passage 15, following a closed loop design for the over-pressurized air. Utilizing this closed loop design in conjunction with the multi-feed multi-pressure supply allows higher thermal efficiency, higher power output, but minimal leakage of over-pressurized cooling air into the gas-path.

FIG. 2 also shows the outer diameter platform 23 with a cooling air hole 26. This cooling air hole 26 can be used to connect one stage or row of stator vanes with a second and adjacent row or stage of stator vanes so that the lower pressure cooling air can be supplies to one stage and then passed on to the second stage for low pressure cooling of the OD cavity 17 and the ID cavity 18 of the stator vanes.

FIG. 5 shows one embodiment of a combined cycle power plant of the present invention which makes use of the turbine stator vane cooling circuit of FIGS. 1-4. The power plant includes a high spool with a high pressure compressor (HPC) 51 driven by a high pressure turbine (HPT) 52 from a hot gas stream produced in a combustor 53 where the high spool drives an electric generator 55. A low spool or turbocharger includes a low pressure compressor (LPC) 62 driven by a low pressure turbine (LPT) 61 that is driven by turbine exhaust from the HPT 52. The LPT 61 includes a variable guide vane assembly 63 to regulate a speed of the LPC 62 and thus control the compressed air flow delivered to the inlet of the HPC 51. The LPC 62 includes a variable inlet guide vane assembly to regulate the speed of the low spool. The LPC 62 delivers compressed air to the HPC 51. An intercooler 65 in compressed air line 67 cools the compressed air from the LPC 62. Regulator valve 66 is in the compressed air line 67. A boost compressor 56 with valve 57 can be used to deliver low pressure air to the inlet of the HPC 51 in certain situations.

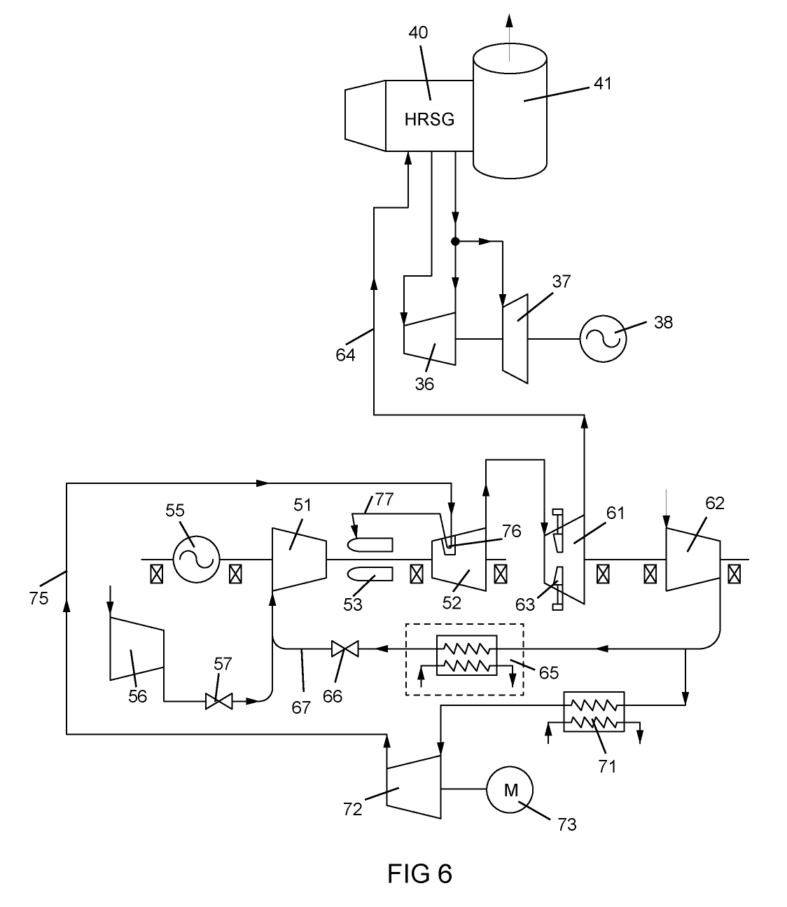

FIG. 6 shows another version of the combined cycle power plant of the present invention in which the turbine stator vanes are cooled using compressed air from the compressed air line 67. Some of the compressed air from the line 67 is diverted into a second intercooler 71 and then further compressed by a boost compressor 72 driven by a motor 73 to a higher pressure than the outlet pressure of the HPC 51 so that the turbine stator vanes 76 can be cooled and the spent cooling air can be discharged into the combustor 53 through spent cooling air line 77. The higher pressure cooling air feed tube 13 and exit tube 15 of the vane in FIG. 2 would be lines 75 and 77 in FIG. 6. The lower pressure cooling air delivered to the lower pressure cooling air feed tube 16 would be discharged from the endwall cavities and into the hot gas stream passing through the turbine 52.

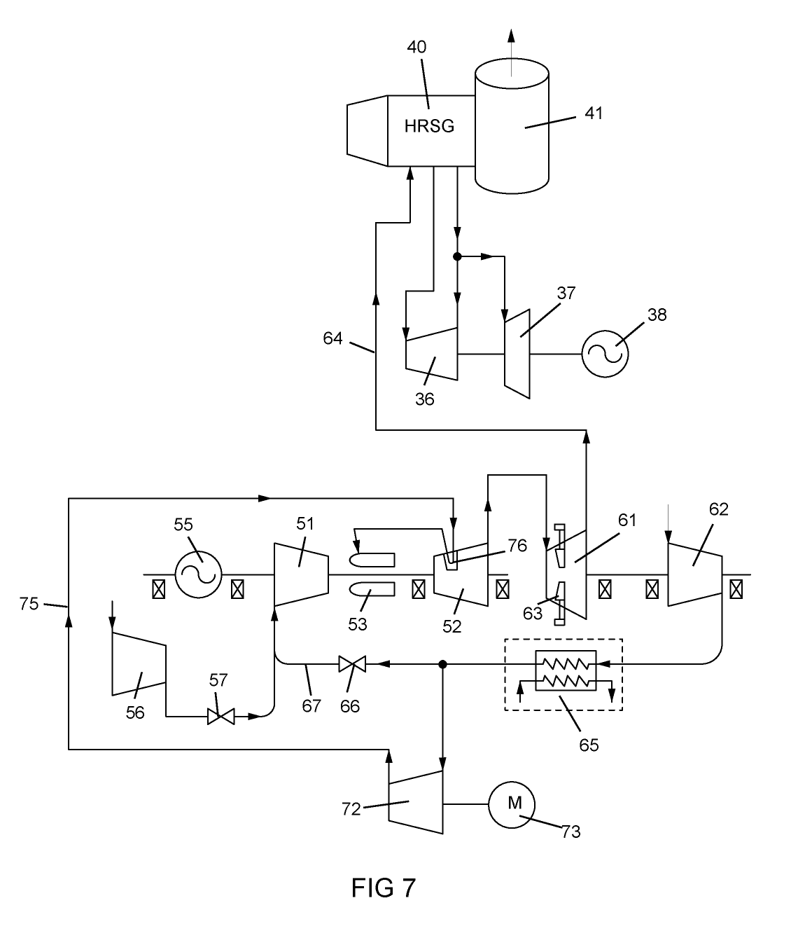

FIG. 7 shows another embodiment of the combined cycle power plant similar to the FIG. 6 embodiment in which only one intercooler 65 is used to cool both the compressed air going to the HPC 51 and to the boost compressor 72.

We claim the following:

1: A stator vane assembly for a gas turbine engine having a closed loop cooling circuit, the stator vane assembly comprising:
an outer diameter platform;
a higher pressure cooling air supply passage in the outer diameter platform;
a higher pressure cooling air exit passage in the outer diameter platform;
a stator vane secured to the outer diameter platform;
an outer diameter endwall cavity formed between the outer diameter platform and the stator vane;
an inner diameter endwall cavity formed on an inner diameter of the stator vane;
an internal cooling air circuit formed within an airfoil of the stator vane;
a lower pressure cooling air supply passage in the outer diameter platform opening into the outer diameter endwall cavity;
a lower pressure cooling air supply passage in the airfoil of the stator vane connecting the outer diameter endwall cavity to the inner diameter endwall cavity;
a supply tube extending through the outer diameter endwall cavity and connecting the higher pressure cooling air passage to the internal cooling air circuit of the airfoil;
an exit tube extending through the outer diameter endwall cavity and connecting the internal cooling air circuit of the airfoil to the higher pressure cooling air exit passage;
an outer diameter lower pressure exit hole connected to the outer diameter endwall cavity; and,
an inner diameter lower pressure exit hole connected to the inner diameter endwall cavity.

2: The stator vane assembly for a gas turbine engine of claim 1, and further comprising:
the higher pressure cooling air passages and internal cooling air circuit form a closed loop cooling circuit through the stator vane assembly.

3: The stator vane assembly for a gas turbine engine of claim 1, and further comprising:
the higher pressure cooling air is at a higher pressure than a discharge pressure from a compressor of the gas turbine engine such that spent cooling from the higher pressure cooling air exit passage can be discharged into a combustor of the gas turbine engine.

4: A method of cooling a stator vane assembly of a gas turbine engine comprising the steps of:
passing a higher pressure cooling air through an internal cooling circuit of an airfoil of the stator vane assembly to cool the airfoil;
discharging the higher pressure cooling air from the internal cooling circuit from the stator vane assembly;
passing a lower pressure cooling air into an outer diameter endwall cavity of the stator vane assembly to cool the outer diameter endwall of the stator vane assembly;
passing some of the lower pressure cooling air from the outer diameter endwall cavity into an inner diameter endwall cavity through the airfoil to cool the inner diameter endwall cavity; and,
discharging spent cooling air from both of the outer diameter and inner diameter endwall cavities outside of the airfoil of the stator vane.

5: The method of cooling a stator vane assembly of a gas turbine engine of claim 4, and further comprising the step of:
passing the higher pressure cooling air through the stator vane assembly in a closed loop such that the higher pressure cooling air is not in fluid communication with the lower pressure cooling air.

6: The method of cooling a stator vane assembly of a gas turbine engine of claim 4, and further comprising the step of:
passing the higher pressure cooling air through the stator vane assembly with enough pressure so that the discharged higher pressure cooling air from the stator vane assembly has enough pressure to flow into a combustor of the gas turbine engine.
